(19) United States
(12) Patent Application Publication
(10) Pub. No.: US 2009/0108108 A1
(43) Pub. Date: Apr. 30, 2009

(54) Spreader

(76) Inventor: Robin Bunning, Dereham (GB)

Correspondence Address: thomas M. Galgano;Galgano & Associates, PLLC, 20 W, Park Avenue, Suite 204, Long Beach, NY, 11561, US

(21) Appl. No.: 12/087,745

(22) PCT Filed: Oct. 10, 2006
(86) PCT No.: PCT/GB2006/003774

§ 371 Date: Jul. 11, 2008

(30) Foreign Application Priority Data
Oct. 11, 2005 (GB) 0520639.6

(51) Int. Cl. A01C 17/00; G01F 11/20

(52) U.S. Cl. 239/666; 222/412

(57) ABSTRACT

An apparatus (10) for distributing solid material such as manure or fertiliser is disclosed. The apparatus (10) has a container body (11) mounted to a chassis and conveying means (17) to move the material from a first end of the container body (11) to a second end. The second end is at least partially open and opens onto one or more rotating augers (14A) the axis of the or each auger (14A) being orientated substantially vertically. Cutter blades (91) are included, orientated radially with respect to the auger axis, which blades (91) can have a trapezoidal shape. The auger (14A) has a helical auger flight (92) of generally circular shape when viewed along the axis of the auger (14A). The circumference of the auger flight (92) has one or more cut-outs (81) whose edge lies on the circumference of a circle or ellipse.

### FIELD OF THE INVENTION

The present invention relates to an improved spreader for use in the farming industry. The spreader is particularly suitable for use in spreading solid material, such as manure and to that end features an improved auger.

### BACKGROUND TO THE INVENTION

It is well known in the farming industry to distribute solid particulate or fibrous semi-liquid materials onto a field. For example, inorganic and organic fertilisers, seeds, pesticides need to be spread across an area which can often be extensive in size. In modem farming especially, it is of importance that the task be carried out as quickly as possible in order to minimise labour and machine costs.

Of particular interest in respect of the current invention is the spreading of fertiliser especially organic fertiliser. Very often the latter is organic waste matter such as manure from cattle sheds, which has been treated to a limited extent prior to its use. The manure is usually a moist solid containing a significant proportion of fibrous material. As such it is difficult to spread evenly across a field.

A number of machines and methods have been developed which facilitate the process. An example of an apparatus which has found particular usefulness includes a container, mounted on wheels, to hold a large amount of manure. The container is used in combination with a horizontally orientated auger. The auger assists in breaking up the manure and imparts momentum thereto, ejecting the manure away from the machine to assist in the distribution. However, the distance the manure is projected from such a machine is relatively small and so the time required to cover a field can be quite large.

It is an object of the present invention to provide a machine for distributing solid waste material which addresses the above problem.

### SUMMARY OF THE INVENTION

According to a first aspect of the invention, there is provided an apparatus for distributing solid material, the apparatus comprising:

a container body mounted to a chassis to retain the solid material;

means to convey the material from a first end of the container body towards a second end, the second end being at least partially open and opening onto one or rotating augers to distribute the material, wherein the axis of the or each auger is orientated substantially vertically. The orientation of the augers enables material to be spread more rapidly over a wider area.

Advantageously, the or each auger is orientated at an angle of up to 15° to the vertical. The angle increases the distance across which the auger sends material.

Optionally, the or each auger includes one or more cutter blades which are advantageously orientated substantially radially with respect to the auger axis. The or each cutter blade preferably has a trapezoidal shape to assist in cutting fibrous matter held in the material being distributed.

Preferably, the or each auger comprises a helical auger flight. Particularly preferably, the auger flight when viewed along the auger axis has a generally circular shape with, the circumference of the auger flight especially preferably including one or more cut out areas. Yet further preferably, the edge of each cut out area forms part of the circumference of a circle or an ellipse. The cut-out provides better material distribution and also enable cutter blades to be more rapidly mounted and de-mounted from the flight.

Optionally, the apparatus comprises two counter-rotating augers. Advantageously, the outer rotational circumference of the augers overlap to allow the augers to co-operate to dispense material and reduce the chance of blockages.

According to a second aspect of the invention there is provided an auger, for use in a farm spreader, the auger having a substantially helical auger flight, the auger flight being, when viewed along its axis, substantially circular, wherein the circumference of the auger flight includes one or more cut-outs. Particularly preferably, the edge of the or each cut-out lies on the circumference of the circle or an ellipse. Particularly preferably the angle between the centres of neighbouring cut-outs relative to the flight axis is 45°.

### BRIEF DESCRIPTION OF THE DRAWINGS

The invention will now be described with reference to the accompanying drawings which show by way of example only, one aspect of an apparatus for spreading solid material. In the drawings:

FIG. 1 is a side illustration of a spreader, with certain elements shown in transparency;

FIG. 2 is an illustration of the top of a spreader with certain elements shown in transparency;

FIGS. 3a, 3b are illustrations of the rear and a section respectively through the container body;

FIG. 4 is a section of a flight having an approximately circular cross-section;

FIG. 5 is a top view of an assembly of two sections of the flight shown in FIG. 4;

FIG. 6 is a side view of the assembly of FIG. 5;

FIG. 7 is a cutter blade;

FIG. 8 is a second embodiment of flight section;

FIGS. 9a-9e illustrates an auger including the second embodiment of flight section;

FIG. 10 shows a top and sectional view through drive means for an auger and;

FIG. 11 illustrates a rubber segment used in the drive means.

### DETAILED DESCRIPTION OF THE INVENTION

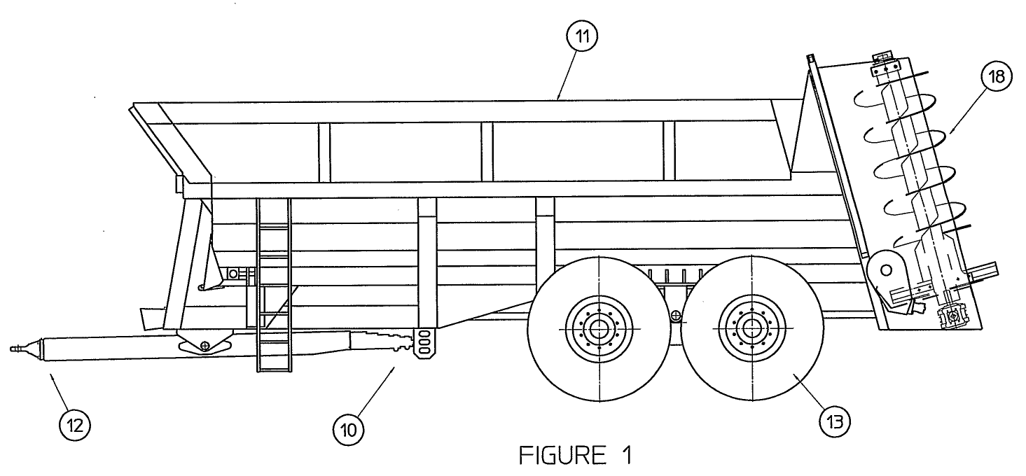

Referring initially to FIGS. 1-3, these illustrate a spreader, generally referenced 10. The spreader 10 as illustrated is designed to be towed behind a motorised unit such as a tractor and also to derive its power from said motorised unit. The spreader can however be a self-propelling vehicle incorporating a power unit and drive system.

The spreader 10 has a container body 11 into which the manure or other solid material to be spread can be added through the open top of the container body 11. The body 11 has a tow bar 12 at its front end to enable the spreader to be connected to a tractor or the like. The weight of the spreader 10 is borne primarily by wheels 13 towards the rear of the spreader 10.

At the rear of the spreader 10, the container body 11 opens out to the augers 14A, 14B. Each auger 14A, 14B is rotatably mounted about its axis.

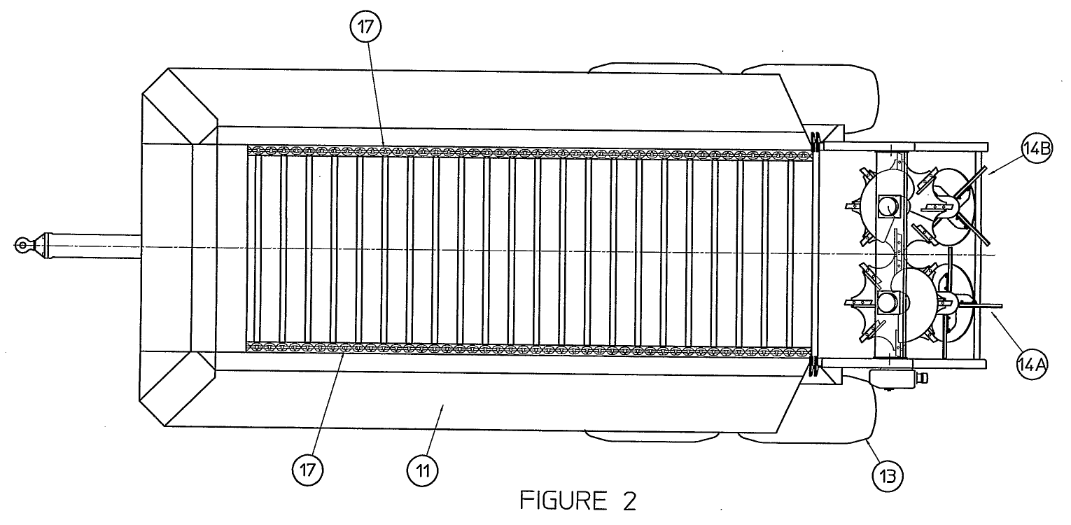

The augers, as exemplified, rotate in a counter-rotating fashion relative to one another, their motion being driven by a common motor 15 through a common gear box 16. As can be seen from FIG. 2, the outer circumferences described by the rotation of the augers overlap and so it is important that the rotation is maintained in such a synchronised fashion.

In use, manure is loaded into the container body 11 and the spreader 10 towed to the area to be covered. The augers 14A, 14B are set in rotation at the pre-set speed. Chain drives 17 are set in motion and act to convey the manure from the front of the container body 11 towards its rear. The manure passes through an opening in the rear wall of the container body 11 and is caught up in the rotating cutter blades of the augers 14A, 14B. The cutter blades at this point act to break up the manure into smaller pieces and to chop down aggregates of material.

The manure then passes onto the main flights 18 of the auger 14A, 14B. Some material is thrown immediately away from the spreader 10 due to the momentum imparted to it by the rotation of the augers 14A, 14B. The rest of the material passes upwardly in contact with the flights 18 of the auger 14A, 14B as the auger acts as a type of Archimedean screw. Eventually however, all the material is ejected from the auger. The distance travelled by material on ejection is increased by virtue of the fact that the axis of the auger is inclined to angle towards the container body, the angle being up to approximately 15°.

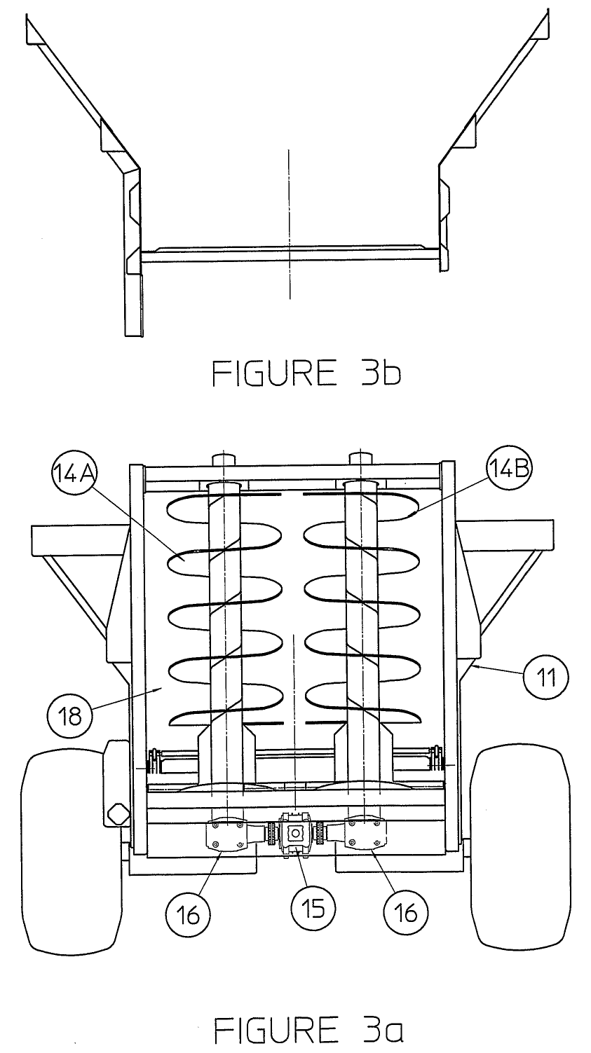

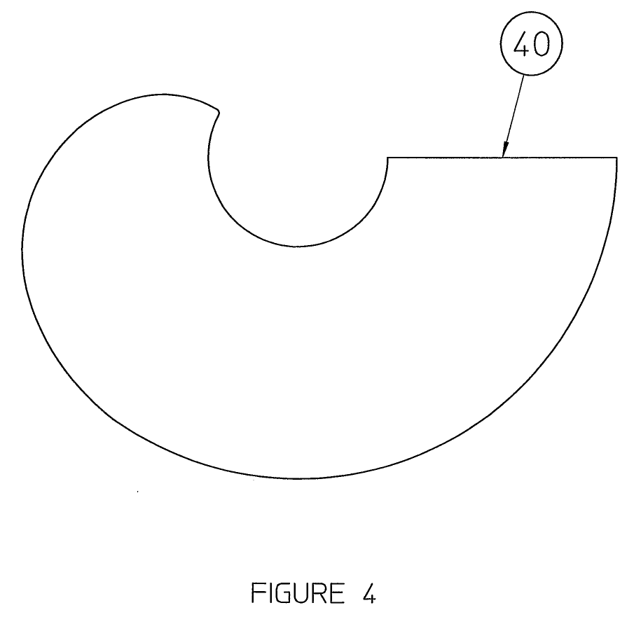

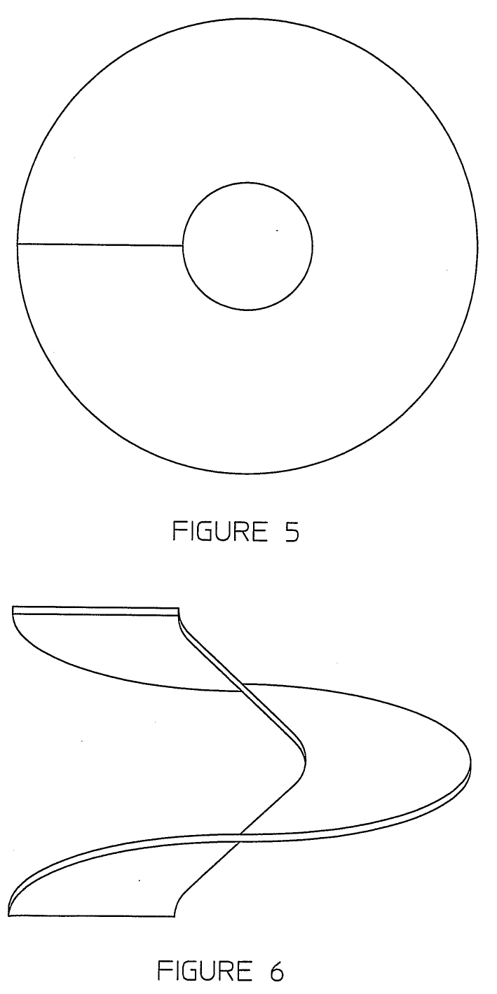

The augers and the flights which form part of the auger themselves are shown in more detail in FIGS. 4-9. FIG. 3a shows a first design of auger in which all sections 40 of the flights (shown in FIG. 4) have a circular section when viewed along the axis of the auger. The auger can further be seen from FIG. 3a to have the form of a helix. The helix is formed by welding together flight sections 40. A section formed on welding together two sections is shown in FIGS. 5 and 6, where the beginnings of the helical configuration of the auger can be seen.

The helical shape allows material to be transported in an upward direction. It will be appreciated by those skilled in the art that as the two augers 14A, 14B are designed to rotate in opposite directions, it will be preferable if their threads are of opposing handedness.

The flight as described above can simply be used in that configuration. It has however, been found that performance is increased if a trapezoidal cutter blade 70 (as shown in FIG. 7) is fixed such that part of the cutter blade 70 projects beyond the outer circumference of the flight section 40. A number of cutter blades 70 are therefore bolted on at regular intervals around the flight section 40. The cutter blades 70 act, in use, to cut up the material being spread, into smaller pieces and therefore to reduce the chance of a blockage.

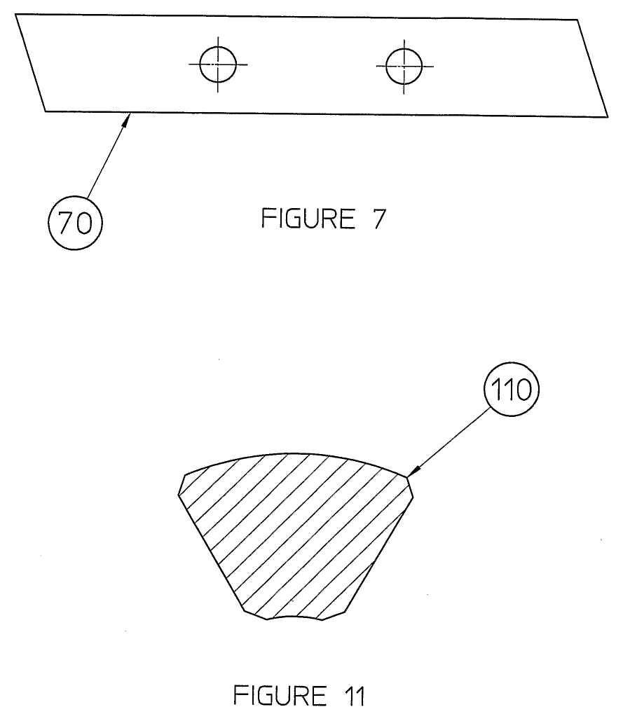

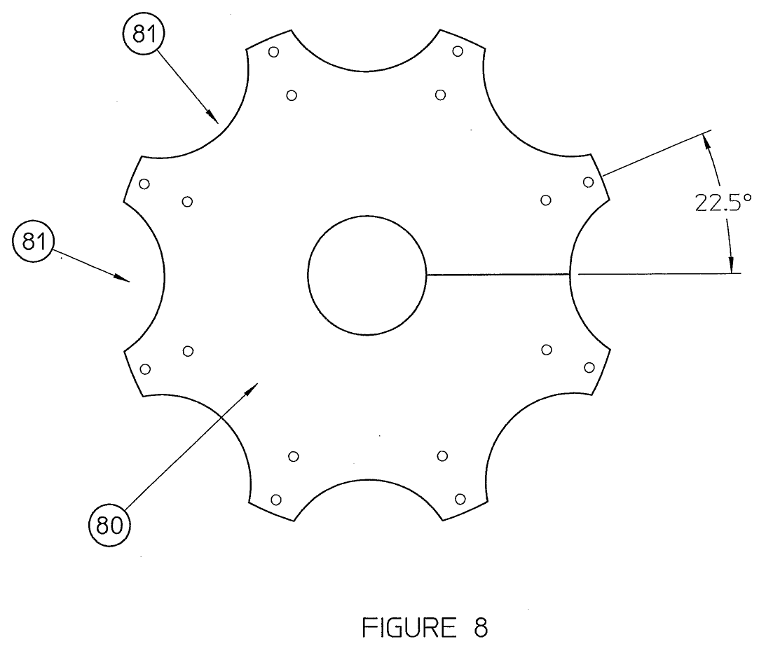

An alternative design of flight section 80 is shown in FIG. 8. The flight section 80 shown here when assembled with other flight sections also provides a flight having a 3-dimensional helical configuration, again assisting the upward transport of material. When viewed along the axis of the auger however, the flight section 80 can be seen to have a different shape to that of the flight section 40 shown above. The flight section 80 is generally circular, but includes eight cut-outs 81, evenly spaced around the circumference. The edge of each cut-out 81 lies on the circumference of a circle or an ellipse. Furthermore, the angle subtended by the centres of the circle or the ellipse and the axis of the auger is 45°.

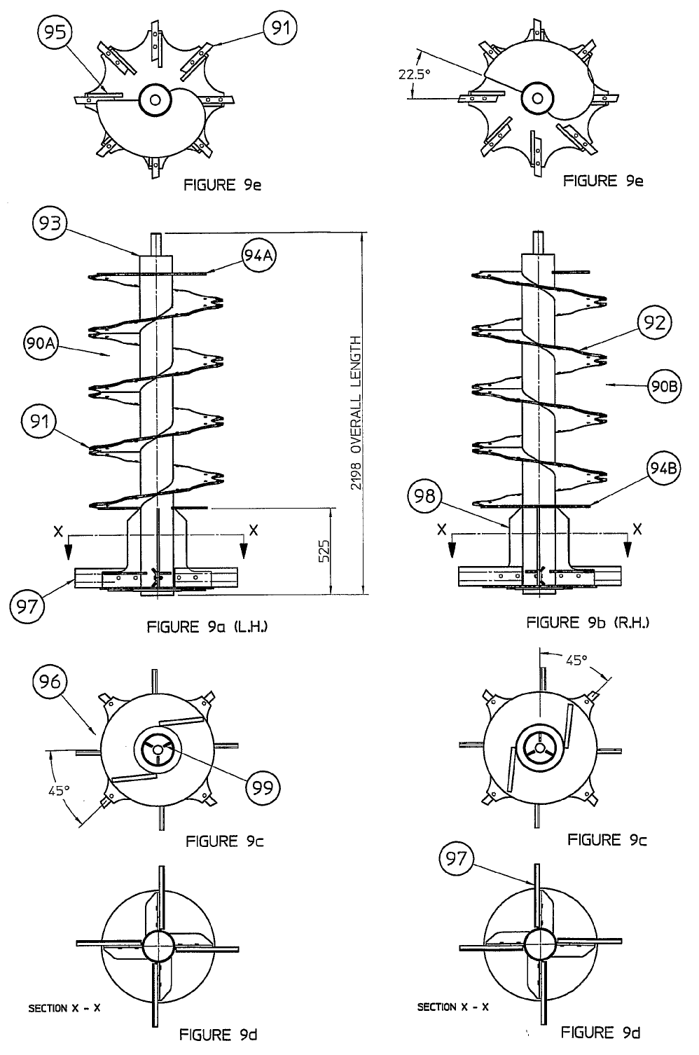

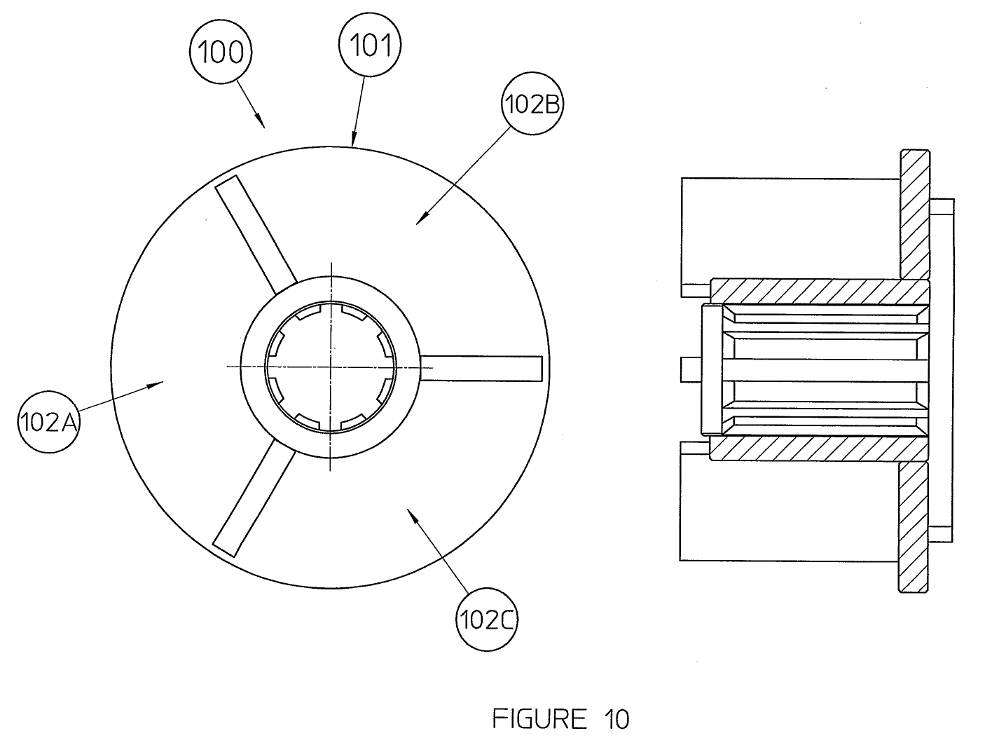

An embodiment of an auger incorporating the flight section 80 of FIG. 8 is shown in FIGS. 9a-9e. FIGS. 9a-9e show two augers 90A, 90B which in use would be used side-by-side in co-operation with one another. The two augers 90A, 90B rotate in counter-rotatory fashion and the shearing force thereby generated assists in cutting up the material to be distributed. As can be seen by comparison of the flights, the level of the flight 92 of the auger in 9b is displaced axially from that in 9a. For the sake of clarity, a number of the cutter blades 91, have been omitted from the drawings.

The auger construction is based around a central tube assembly. Towards the upper and lower end of a tube 93 is welded an upper and a lower snail 94A, 94B respectively. Between the distance defined by the snails 94A,94B a substantially helical auger flight 92 is welded into position.

In order to assist the spreading process, cutter blades 91 supported at one side by a bar 95 welded to the flight 92, are bolted to the outer circumference region of the flight 92. Beneath the lower snail 94B, the bottom disk 96 is welded around the lower end of the tube 93. The disk 96 supports paddles 97 which act to remove material which falls from the container body 11 and past the auger flights 92. To provide additional support for the flights 92, the auger 90 includes auger feet 98 supported on the bottom disk 96.

FIG. 9c shows the means by which the rotation of the auger 90A,90B is driven. The inside of the tube 93 includes baffles 99, which engage a drive element 100 of complementary shape. The drive element 100 is linked to the gear box and so provides a coupling between the gear box and the auger. The drive element casing 101 is basically of cylindrical shape, open at one end. The element includes three substantially wedge shaped rubber elements 110 (shown in FIG. 11) which are secured at regular intervals around the inside of the casing 101 at 102A, 102B, 102C leaving sufficient gap between the neighbouring wedge 110 for insertion of the baffles 99.

It will of course be understood that the invention is not limited to the specific details described herein, which are given by way of example only, and that various modifications and alterations are possible within the scope of the invention.

1. An apparatus for distributing solid material, the apparatus comprising:
a container body mounted to a chassis to retain the solid material;
means to convey the material from a first end of the container body towards a second end, the second end being at least partially open and opening onto one or rotating augers to distribute the material, characterized in that the axis of the or each auger is orientated substantially vertically.

2. An apparatus according to claim 1, wherein each auger is orientated an angle of up to 15° to the vertical.

3. An apparatus according to claim 1, wherein each auger includes at least one cutter blade.

4. An apparatus according to claim 3, wherein each cutter blade is orientated substantially radially with respect to the auger axis.

5. An apparatus according to claim 3, wherein each cutter blade has a trapezoidal shape.

6. An apparatus according to claim 1, wherein each auger comprises a helical auger flight.

7. An apparatus according to claim 6, wherein the auger flight when viewed along the auger axis has a generally circular shape.

8. An apparatus according to claim 7, wherein the circumference of the auger flight includes at least one cut out area.

9. An apparatus according to claim 8, wherein the edge of each cut out area forms part of the circumference of a circle.

10. An apparatus according to claim 1 comprising two counter-rotating augers.

11. An apparatus according to claim 10, wherein the outer rotational circumference of the augers overlap.

12. An auger, for use in a farm spreader, the auger having a helical auger flight the auger flight being, when viewed along its axis generally circular, wherein the circumference of the auger flight includes at least one cutout.

13. An auger according to claim 12, wherein the edge of each cut-out lies on the circumference of a circle.

14. An auger according to claim 13, wherein the angle between the centers of neighboring cut-outs relative to the flight axis is 45°.

15. An apparatus according to claim 2 wherein each auger includes at least one cutter blade.

16. An apparatus according to claim 4 wherein each cutter blade has a trapezoidal shape.

17. An apparatus according to claim 9 wherein the edge of each cut out area forms part of the circumference of an ellipse.
